(19) United States
(12) Patent Application Publication
(10) Pub. No.: US 2009/0061653 A1
(43) Pub. Date: Mar. 5, 2009

(54) Connector unit and connector thereof

(76) Inventors: Hiroyuki Mizushina, Tokyo (JP); Hiroyuki Miura, Kawasaki-shi (JP); Mitsunori Hanaka, Kumagaya-shi (JP)

Correspondence Address: COLLARD & ROE, P.C., 1077 NORTHERN BOULEVARD, ROSLYN, NY, 11576, US

(21) Appl. No.: 12/231,487

(22) Filed: Sep. 3, 2008

(30) Foreign Application Priority Data
Sep. 4, 2007 (JP) 2007-229309

(51) Int. Cl. H01R 12/14

(52) U.S. Cl. 439/63

(57) ABSTRACT

A connector unit comprises a case, a substrate and a connector. The case is formed with an opening. The substrate is installed within the case and is formed with a signal conductive pattern and a ground conductive pattern. The ground conductive pattern is electrically connected to the case. The connector comprises a contact, an outer conductor and a high impedance member. The outer conductor is electrically connected to the ground conductive pattern. The outer conductor is insulated from the contact but covers, at least in part, the contact. The contact is electrically connected to the signal conductive pattern. The high impedance member has high impedance in a high frequency range. The high impedance member is positioned between the outer conductor and the case within the opening of the case. For example, the high impedance member is an electric wave absorber.

### CROSS REFERENCE TO RELATED APPLICATIONS

Applicants claim priority under 35 U.S.C. §119 of Japanese Application No. 2007-229309 filed Sep. 4, 2007.

### BACKGROUND OF THE INVENTION

This invention relates to a connector connecting a coaxial cable and a substrate, and a connector unit comprising the same.

Connector unit of the above-mentioned type are disclosed in, for example, JP-A 2004-273236, JP-A 2003-203716 and JP-A H8-45620, each of which is incorporated herein by reference in its entirety. The disclosed type connector unit comprises a case, a connector and a substrate. The substrate is installed with in the case and is formed with a signal conductive pattern and a ground conductive pattern. The connector comprises a contact and the outer conductor insulated from the contact. The connector is partially accommodated with in the case so that a coaxial cable can be connected to the connector outside the case. Within the case, the connector is attached to the substrate so that the contact and the outer conductor are connected to the signal conductive pattern and the ground conductive pattern, respectively.

### SUMMARY OF THE INVENTION

It is an object of the present invention to provide a connector unit that has an improved high-frequency property and a connector used therein.

In accordance with one aspect of the present invention, there is provided a connector which is to be partially accommodated within a case through an opening of the case and which is to be attached to a substrate installed within the case. The connector comprises a contact, an outer conductor and a high impedance member. The outer conductor is insulated from the contact and covers, at least in part, the contact. The high impedance member has high impedance in a high frequency range. The high impedance member is fixed to the outer conductor so that, when the connector is arranged through the opening of the case, the high impedance member covers the outer conductor within the opening of the case.

In accordance with another aspect of the present invention, there is provided a connector unit comprising a case, a substrate and a connector. The case is formed with an opening. The substrate is installed within the case and is formed with a signal conductive pattern and a ground conductive pattern. The ground conductive pattern is electrically connected to the case. The connector comprises a contact, an outer conductor and a high impedance member. The outer conductor is electrically connected to the ground conductive pattern. The outer conductor is insulated from the contact but covers, at least in part, the contact. The contact is electrically connected to the signal conductive pattern. The high impedance member has high impedance in a high frequency range. The high impedance member is positioned between the outer conductor and the case within the opening of the case.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a partial, enlarged view of a connector unit according to a first embodiment of the present invention;

FIG. 2 is a cross sectional view of the connector unit, taken along lines II-II of FIG. 1;

FIG. 3 is a partial, enlarged view of a connector unit according to a second embodiment of the present invention;

FIG. 4 is a cross sectional view of the connector unit, taken along lines IV-IV of FIG. 3;

FIG. 5 is a graph showing a reflectance loss property of the connector of FIG. 1, wherein an electromagnetic wave absorber is inserted as a high impedance member between an outer conductor of the connector and the case.

FIG. 6 is a graph showing a reflectance loss property of a comparative connector, wherein no member is inserted between an outer conductor of the comparative connector and the case so that the outer conductor is spaced from the case.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DESCRIPTION OF THE PREFERRED EMBODIMENT

### First Embodiment

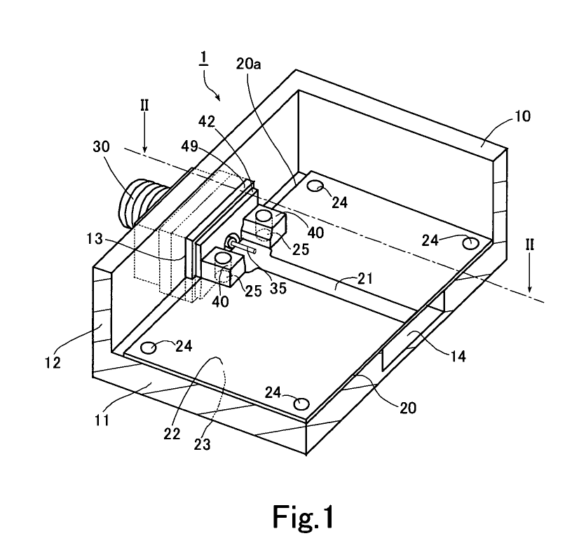

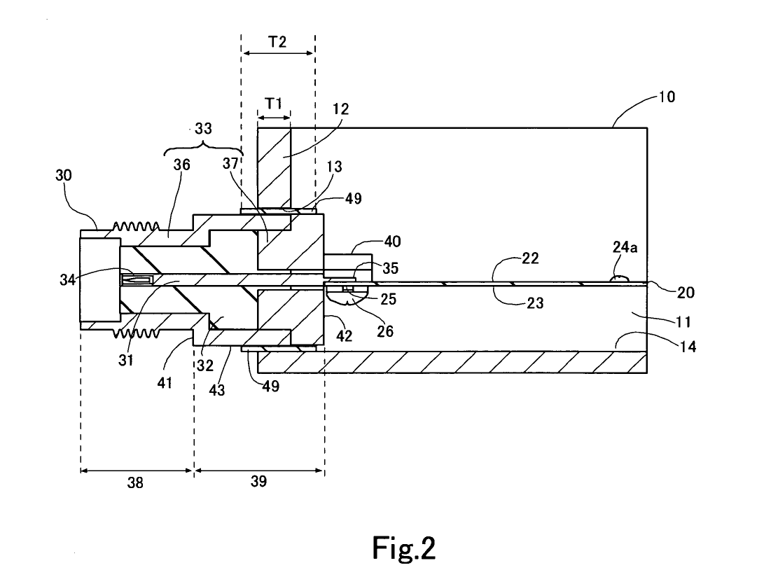

With reference to FIGS. 1 and 2, a connector unit 1 according to a first embodiment of the present invention comprises a case 10, a substrate 20 and a connector 30.

The case 10 comprises a sidewall 12 and a bottom portion 11. The sidewall 12 extends upward from a front edge of the bottom portion 11 and has an opening 13 through which the connector 30 is partially inserted. The opening 13 of this embodiment has a rectangular shape. The bottom portion 11 is formed with a groove 14. The groove 14 has a bottom which is in a level same as that of a lower edge of the opening 13. The groove 14 extends backward from the front edge of the bottom portion 11.

The substrate 20 has a top surface 22, a bottom surface 23 and a front end 20a. The substrate 20 is provided with a signal conductive pattern 21, a ground conductive pattern, four first fix portions 24 and two second fix portions 25. The signal conductive pattern 21 is formed on the top surface 22 and extends backward from the front end 20a. The ground conductive pattern is formed on the bottom surface 23, although the ground conductive pattern is not shown in the drawings. Each first fix portion 24 is formed in the vicinity of a corner of the substrate 20. The substrate 20 is fixed to the bottom portion 11 by screws 24a at the first fix portions 24 so that the substrate 20 is supported by the bottom portion 11 of the case 10. In other words, the bottom portion 11 of the case 10 serves as a support portion for supporting the substrate 20. Each second fix portion 25 is formed in the vicinity of the front end 20a. In this embodiment, the signal conductive pattern 21 is formed between the second fix portions 25 but is physically and electrically isolated from the second fix portions 25. The second fix portions 25 are electrically connected to the first fix portions 24 through the ground conductive pattern. The first fix portions 24 are electrically connected to the bottom portion 11 of the case 10 by the screws 24a. Thus, the second fix portions 25 are electrically connected to the case 10 through the ground conductive pattern and the first fix portions 24.

With reference to FIG. 2, the connector 30 according to the present embodiment is a coaxial connector for high frequency circuit and is partially accommodated within the case 10 so that a coaxial cable can be connected to the connector 30 outside the case 10 by using a mating connector coupled to the coaxial cable; the coaxial cable and the mating connector are not shown for the sake of clarity. The connector 30 comprises a contact 31, a housing 32, an outer conductor 33 and a high impedance member 49.

The contact 31 has a linear shape and comprises a front end portion 34 and a rear end portion 35. The contact 31 is held by the housing 32 so that the contact 31 is parallel to the top surface 22 of the substrate 20. The front end portion 34 is a female contact portion connectable to a male contact portion of the mating connector. The front end portion 34 may be a male contact portion, while the mating connector may be provided with the female contact portion connectable to the male contact portion. As apparent from FIGS. 1 and 2, the rear end portion 35 is connected to the signal conductive pattern 21. The rear end portion 35 of this embodiment has a diameter smaller than that of the front end portion 34 of the contact 31.

The housing 32 covers the contact 31, and the outer conductor 33 covers the housing 32. The outer conductor 33 is electrically and physically insulated from the contact 31.

As shown in FIG. 2, the outer conductor 33 is comprised of two members 36 and 37. In shape, the outer conductor 33 consists of four portions: a connect portion 38; a body portion 39; and two fixed portions 40. The body portion 39 has a rectangular parallelepiped shape and has a front end 41 and a rear end 42. The body portion 39 is positioned in part within the opening 13. The connect portion 38 has a cylindrical shape and projects forward from the front end 41. The connect portion 38 is positioned outside of the case 10. Specifically, the connect portion 38 of this embodiment has a circumference formed with a screw thread for connecting the mating connector. Each fixed portion 40 projects backward from the rear end 42 and is formed with a screw hole. In this embodiment, the fixed portions 40 are arranged in the symmetrical positions with respect to the rear end portion 35. The fixed portions 40 are fixed to the second fix portion 25 of the substrate 20 by screws 26 so that the outer conductor 33 is electrically connected to the ground conductive pattern of the substrate 20.

The high impedance member 49 is made of an electromagnetic wave absorber, especially, a noise suppression sheet. However, the present invention is not limited thereto. Instead of the noise suppression sheet, the connector 30 may comprise another electromagnetic wave absorber obtained by painting or plating an electromagnetic wave absorption material. Furthermore, instead of the electromagnetic wave absorber, the connector 30 may comprise another high impedance member that has high impedance in a high frequency range.

The high impedance member 49 is positioned between the outer conductor 33 and the sidewall 12 of the case 10 within the opening 13. In this embodiment, the high impedance member 49 has a length T2 which is larger than a thickness T1 of the sidewall 12. However, the present invention is not limited thereto. The high impedance member 49 may have another length not larger than the thickness T1 and be completely surrounded by the sidewall 12 of the case 10.

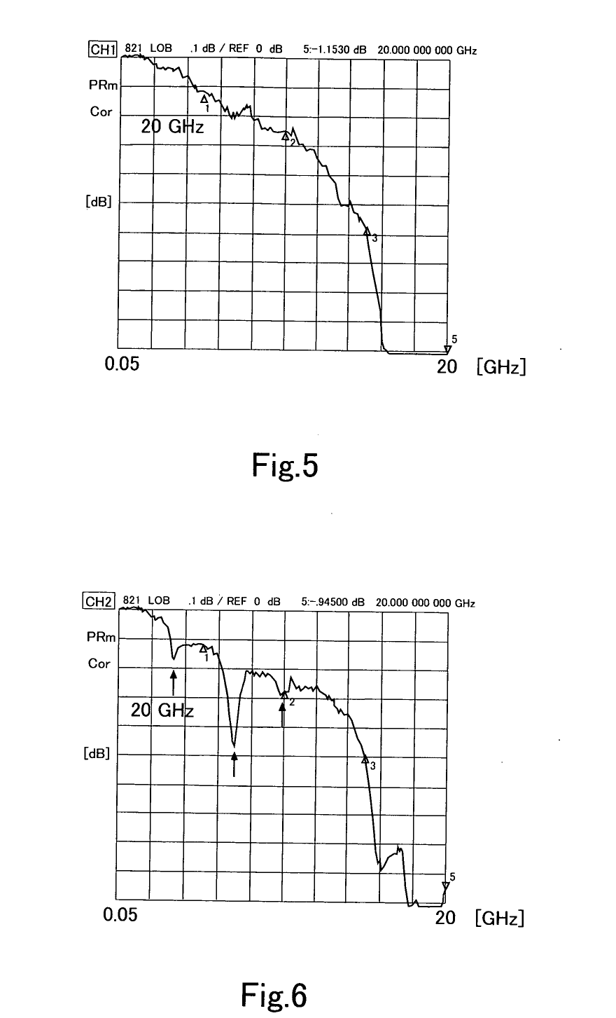

Analyses were made about the above-mentioned connector unit 1 and another comparative connector unit. The comparative connector unit comprises a comparative connector which comprises no high impedance member between the outer conductor of the comparative connector and the case. In other words, the comparative connector unit comprises an air-gap between the outer conductor of the comparative connector and the case. Results of the connector unit 1 of this embodiment and the comparative connector unit are shown in FIGS. 5 and 6, respectively.

With reference to FIG. 6, acute attenuation points can be seen at some specific frequencies. It is conceivable that the outer conductor, the case and the gap between them serve as a capacitor of undesired resonant circuit, and the undesired resonant circuit resonates at the specific frequencies and causes the acute attenuation points. On the other hand, such acute attenuation points cannot seen on the graph of FIG. 5 because of the high impedance member 49 inserted between the outer conductor 33 and the sidewall 12 of the case 10.

### Second Embodiment

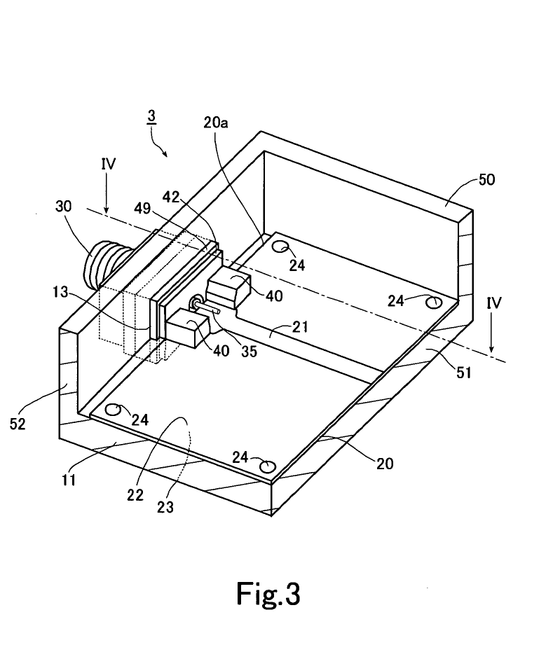

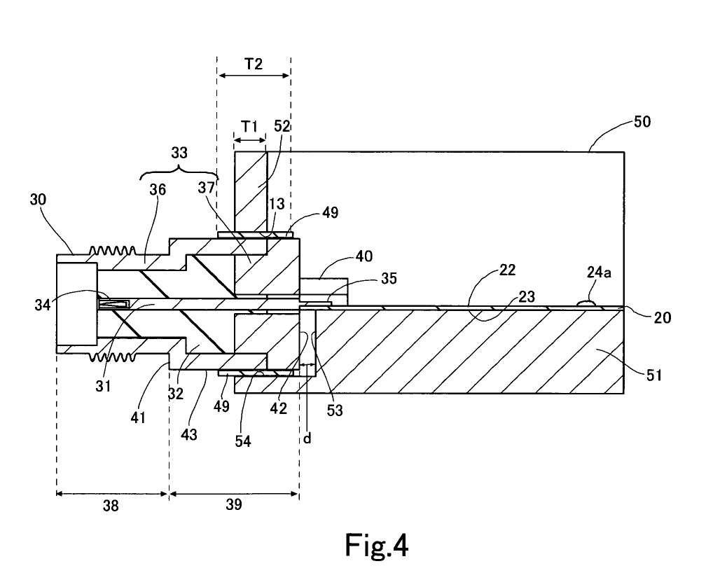

With reference to FIGS. 3 and 4, a connector unit 3 according to a second embodiment is similar to that of the first embodiment. In FIGS. 3 and 4, the same reference numbers are given to the components same as those illustrated in FIGS. 1 and 2, and the description therefor will be omitted.

With reference to FIG. 4, a bottom portion 51 of a case 50 of this embodiment is formed with a recessed portion 54. The recessed portion 54 has a bottom which is in a level same as that of the lower edge of the opening 13 formed in a sidewall 52 of the case 50. The recessed portion 54 extends backward from the front edge of the bottom portion 51. The recessed portion 54 has a rear end surface 53 which stands up from the bottom of the recessed portion 54.

The substrate 20 is secured to the bottom portion 51 by using screws 24a so that the substrate 20 is supported by the bottom portion 51 of the case 50. In other words, the bottom portion 51 of the case 50 serves as a support portion for supporting the substrate 20. The top surface 22 of the substrate 20 is formed with two mount portions, on each of which the fixed portions 40 of the outer conductor 33 are fixed and electrically connected by soldering. Furthermore, the mount portions are electrically connected to the first fix portions 24 through a ground conductive pattern or another conductive pattern. The first fix portions 24 are electrically connected to the bottom portion 51 by screws 24a. Thus, the outer conductor 33 of the connector 30 is electrically connected to the case 50.

As shown in FIG. 4, the rear end 42 of the connector 30 is spaced and isolated from the rear end surface 53 of the recessed portion 54. Accordingly, the outer conductor 33 of the connector 30 is spaced from the bottom potion 51 of the case 50. In other words, there is provided a distance “d” between the rear end 42 of the connector 30 and the rear end surface 53 of the recessed portion 54 i.e. the bottom portion 51 of the case 50. In this embodiment, the distance “d” is designed so that electromagnetic connection is prevented from occurring between the outer conductor 33 and the bottom portion 51.

In the above-described embodiments, the center portion 39 of the connector 30 has a rectangular parallelepiped shape, however, the center portion 39 may have a cylindrical shape.

The present application is based on a Japanese patent application of JP2007-229309 filed before the Japan Patent Office on Sep. 4, 2007, the contents of which are incorporated herein by reference.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A connector which is to be partially accommodated within a case through an opening of the case and is to be attached to a substrate installed within the case, the connector comprising a contact, an outer conductor and a high impedance member, the outer conductor being insulated from the contact and covering, at least in part, the contact, the high impedance member having high impedance in a high frequency range, the high impedance member being fixed to the outer conductor so that, when the connector is arranged through the opening of the case, the high impedance member covers the outer conductor within the opening of the case.

2. The connector according to claim 1, wherein the high impedance member is an electromagnetic wave absorber.

3. A connector unit comprising a case, a substrate and a connector, the case being formed with an opening, the substrate being installed within the case and is formed with a signal conductive pattern and a ground conductive pattern, the ground conductive pattern being electrically connected to the case, the connector comprising a contact, an outer conductor and a high impedance member, the outer conductor being electrically connected to the ground conductive pattern, the outer conductor being insulated from the contact but covering, at least in part, the contact, the contact being electrically connected to the signal conductive pattern, the high impedance member having high impedance in a high frequency range, the high impedance member being positioned between the outer conductor and the case within the opening of the case.

4. The connector unit according to claim 3, wherein the high impedance member is an electromagnetic wave absorber.

5. The connector unit according to claim 3, wherein the case comprises a support portion for supporting the substrate, the outer conductor having a rear end, the rear end being positioned inside the case but is spaced from the support portion.

6. The connector unit according to claim 3, wherein the connector is a coaxial connector for high frequency circuit.
